(19) United States
(12) Patent Application Publication
(10) Pub. No.: US 2025/0303297 A1
(43) Pub. Date: Oct. 2, 2025

(54) Level Generation for Computer Games

(71) Applicant: Electronic Arts Inc., Redwood City, CA (US)

(72) Inventors: Mónica Villanueva Aylagas, Stockholm (SE); Joakim Bergdahl, Stockholm (SE); Alessandro Sestini, Stockholm (SE); Linus Gisslen, Stockholm (SE)

(21) Appl. No.: 18/621,778

(22) Filed: Mar. 29, 2024

(51) Int. Cl. A63F 13/60; A63F 13/52

(52) U.S. Cl. CPC A63F 13/60; A63F 13/52

(57) ABSTRACT

This specification describes systems, methods and apparatus for generating computer game levels using machine learning. According to a first aspect of this specification, there is described a computer implemented method comprising: extracting, from a known computer game level in a training dataset of known computer game levels for a computer game, a set of level features; processing, using an encoder neural network model, the known computer game level to generate an embedding of the known computer game level; processing, using a decoder neural network model, the embedding of the known game level and the set of level features to generate data indicative of a candidate computer game level for the computer game; determining a value of an objective function based on the data indicative of the candidate computer game level; and updating parameters of the encoder model and/or decoder model based at least in part on the value of the objective function.

### FIELD

This specification describes systems, methods and apparatus for generating computer game levels using machine learning.

### BACKGROUND

Procedural Content Generation (PCG) has been widely used in video game development to increase replayability, present the player with personalized content, or ease the burden of intensive live service content creation, such as in mobile games. In the past, PCG strategies mainly included rule-based generation or planning. The introduction of Procedural Content Generation through Machine Learning (PCGML) has the potential to revolutionize the field by reducing the need for hand-crafted elements, using techniques that take advantage of existing content or learn through interaction with the environment.

Most works that learn from existing data, including data from humans, use generative models. However, these models are not infallible and do not always yield the desired results. For example, they tend to commit mistakes that are evident to humans. In the context of level creation, mistakes can mean that the level is unplayable or unsolvable, e.g. important elements like keys or doors are inaccessible or missing.

### SUMMARY

According to a first aspect of this specification, there is described a computer implemented method comprising: extracting, from a known computer game level in a training dataset of known computer game levels for a computer game, a set of level features; processing, using an encoder neural network model, the known computer game level to generate an embedding of the known computer game level; processing, using a decoder neural network model, the embedding of the known game level and the set of level features to generate data indicative of a candidate computer game level for the computer game; determining a value of an objective function based on the data indicative of the candidate computer game level; and updating parameters of the encoder model and/or decoder model based at least in part on the value of the objective function.

Extracting, from the known computer game level in the training dataset of known computer game levels for the computer game, the set of level features may comprise: extracting the set of level features from the known computer game level using a reinforcement learning algorithm or a scripted bot. In some examples human tester may alternatively or additionally be used to extract level features.

The set of level features may comprise one or more of: data indicative of a level difficulty of the known computer game level; a level symmetry of the known computer game level; a level size of the known computer game level; and/or a level style of the known computer game level.

The set of level features may comprise a level symmetry of the known computer game level. Processing, using the encoder neural network model, the known computer game level to generate the embedding of the known computer game level may comprise: generating a mask based on the level symmetry of the known computer game level; applying the mask to the known computer game level to generate a masked known computer game level; and processing, by the encoder neural network model, the masked known computer game level to generate the embedding of the known computer game level. Determining the value of an objective function based on the data indicative of the candidate computer game level may comprise: applying the mask to the data indicative of the candidate computer game level to generate masked candidate level data; and determining the value of an objective function based on the masked candidate level data.

The encoder neural network model may comprise: one or more convolutional layers; and one or more fully connected layers configured to down-sample the output of the one or more convolutional layers to generate the embedding of the known computer game level. The decoder neural network model may comprise: one or more fully connected layers configured to up-sample decoder input data comprising the embedding of the known game level and the set of level features; and one or more convolutional layers subsequent to the one or more fully connected layers.

The objective function comprises a reconstruction loss, such as a cross entropy loss, and/or a Kullback-Leibler divergence

The known computer game level and candidate computer game level may be game levels for a two-dimensional game environment or a three-dimensional game environment.

Processing, using the encoder neural network model, the known computer game level to generate an embedding of the known computer game level may comprise: determining a set of encoder conditioning data from features extracted from the known computer game level; generating encoder input data from the known computer game level based on the set of encoder conditioning data; and processing, by the encoder neural network model, the encoder input data to generate the embedding of the known computer game level. The level features may comprise one or more of: a level difficulty; a level size; and/or a level symmetry.

According to a further aspect of this specification, there is described a computer implemented method comprising: receiving target data comprising data indicative of a target level difficulty and one or more target level features; sampling an initialisation vector from a distribution; inputting the initialisation vector and the target data into a decoder model; processing, by the decoder model, the initialisation vector and the target data to generate data indicative of a computer game level layout; and outputting the data indicative of a computer game level layout from the decoder model.

The decoder neural network model may comprise: one or more fully connected layers configured to up-sample decoder input data comprising the embedding of the known game level and the set of level features; and one or more convolutional layers subsequent to the one or more fully connected layers.

The method may further comprise causing a computer game level to be generated based on the data indicative of a computer game level layout.

The computer game level may be a game level for a two-dimensional game environment. The computer game level may be a game level for a three-dimensional game environment. The data indicative of a computer game level layout may comprise one or more image maps corresponding to one or more of: a height map; an object placement map; and/or a texture map.

According to a further aspect of this specification, there is described a system comprising: one or more processors; and a non-volatile computer readable storage medium comprising computer readable instructions that, when executed by the one or more processors, cause the system to perform a method comprising: receiving target data comprising data indicative of a target level difficulty and one or more target level features; sampling an initialisation vector from a distribution; inputting the initialisation vector and the target data into a decoder model; processing, by the decoder model, the initialisation vector and the target data to generate data indicative of a computer game level layout; and outputting the data indicative of a computer game level layout from the decoder model.

The decoder neural network model may comprise: one or more fully connected layers configured to up-sample decoder input data comprising the embedding of the known game level and the set of level features; and one or more convolutional layers subsequent to the one or more fully connected layers.

The computer readable instructions may further cause the system to generate a computer game level based on the data indicative of a computer game level layout.

The computer game level may a game level for a two-dimensional game environment or a three-dimensional game environment.

According to a further aspect of this specification, there is described a non-transitory computer readable medium containing computer-readable instructions that, when executed by data processing apparatus, cause the data processing apparatus to perform any one or more of the methods described herein.

### BRIEF DESCRIPTION OF THE DRAWINGS

FIG. 1 shows a schematic overview of an example system/method for generating a computer game level layout using a machine-learning model;

FIG. 2 shows a schematic overview of an example system/method for training a machine learning model to generate a computer game level layout;

FIG. 3 shows a flow diagram of an example method for generating a computer game level;

FIG. 4 shows a flow diagram of an example of a method for training a model to generate a computer game level; and

FIG. 5 shows a schematic example of a system/apparatus for performing any of the methods described herein.

### DETAILED DESCRIPTION

Generative models for level generation have shown potential in games and game production. However, they often provide limited control over the generation, and the validity of the generated levels is unreliable.

This specification describes systems, methods and apparatus for generating computer game level designs using machine-learning models that learn from existing level designs using gameplay statistics. In particular, this specification describes the use of generative models, e.g., a conditional Variational AutoEncoder (cVAE) or Generative Adversarial Network (GAN), to generate level layouts, conditioning the model on pre-collected statistics, such as relevant visual features like size and symmetry and game mechanics like difficulty. The approaches described herein generate more valid levels than the same method without difficulty conditioning. Moreover, the approaches described herein unlock a new degree of control in the generation of computer game levels, allowing level designers to request specific difficulty levels.

This specification describes Auto-Validated Level Generation, a framework that can enhance generative models using validation information during training. This approach is referred to as auto-validation to emphasize that by guiding the generator to produce valid levels during training, the need for post-generation validation is reduced. The methods described herein allow learning from examples to mimic the style of designers while guiding the generation by leveraging agent or human playthroughs that validate if the level can be completed and how.

Implementations of the systems and methods described herein may realise one or more of the following advantages. The generator allows designers to use existing levels to generate new ones in a similar style while creating more valid levels than with other approaches. This can reduce the time and resources required for a designer to generate new, valid level designs. Additional sources of control are also provided in the generation. In particular, by conditioning on the difficulty, this parameter becomes a controllable input for generation in addition to helping create more valid levels. A Flexible validation approach may also be provided that leverages statistics related to gameplay, enabling the use of different sources of validation and reducing the need for domain knowledge of the game. Potential validation approaches include scripted bots, pretrained RL agents, or even human testers.

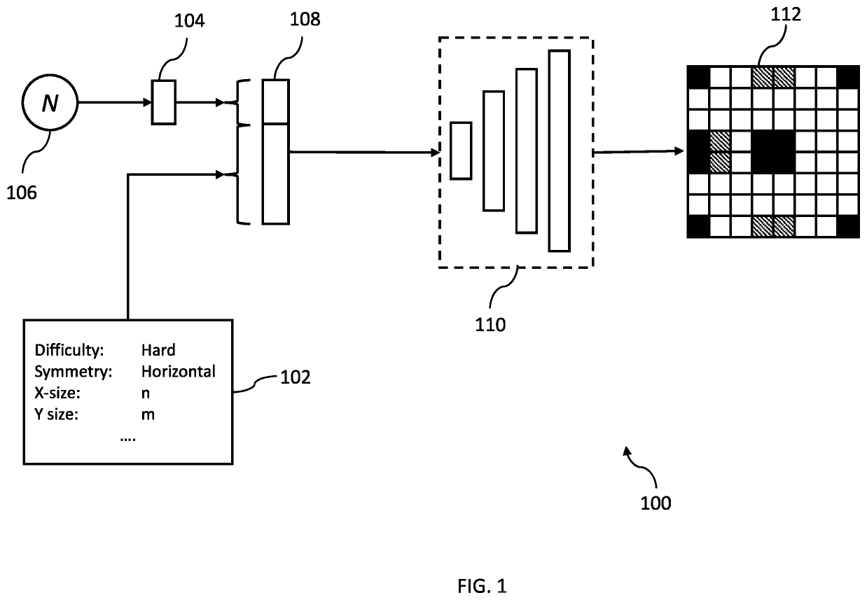

FIG. 1 shows a schematic overview of an example system/method 100 for generating computer game level data using a machine-learning model.

A set of target data 102 is received from a user that defines one or more target properties of a game level. Initialisation data 104 is sampled from a predefined distribution 106, e.g., a normal distribution, such as a zero mean, isotropic Gaussian distribution. The initialisation data 104 is combined with the target data 102 to form input data 108 for a decoder model 110 (also referred to herein as a decoder neural network). The decoder model 110 processes the input data 108 to generate computer game level data 112 indicative of a layout of a computer game level.

The set of target data 102 comprises an indication of a target difficulty for the computer game level. The target difficulty may be input by a user. Alternatively the target difficulty may be generated automatically, for example based on player-statistics (e.g., the difficult of recently completed game levels by the player) and/or randomly. The target difficulty may be a categorical difficulty level. For example, the target difficulty may be taken from a set of difficulty level categories, such as the set {“easy”; “normal”; “hard”; “extreme”} or the like. Alternatively or additionally, the target difficulty may be numerical indication of a difficulty level. For example, the target difficulty may comprise one or more of a target number of moves to complete a level, a target time to complete the level, and/or a numerical score indicating a fraction of a maximum difficulty.

The set of target data 102 further comprises one or more target level features. The one or more target level features define desired properties of the level being generated. The one or more target level features may at least in part be defined by a user input. The set of target data 102 is, in some examples, represented as a k-dimensional vector, where k>1.

In some implementations, the one or more target level features comprises one or more level dimensions. For example, the one or more target level features may comprise a horizontal size of the level (i.e., an x-size) and a vertical size of the level (i.e., a y-size). In some three-dimensional examples, a z-size of the level may also be specified in the one or more target level features. The level size may, for example, be defined in terms of “blocks” (i.e., discrete units of the game level), pixels, or in-game distances.

In some implementations, the one or more target level features comprises an indication of a level symmetry. For example, the one or more target level features may indicate that the level symmetry should have a horizontal and/or vertical reflective symmetry. Alternatively or additionally, the one or more target level features may indicate a level of rotational symmetry of the level, e.g., a two-fold or four-fold rotational symmetry.

In some implementations, the one or more target level features comprises a target style for the level. The target style defines one or more style features of the level being generated. The target style may define a target playstyle that the level should be aimed at. For example, a target playstyle may include one or more of: an aggressive playstyle; a fast playstyle; a defensive playstyle; a balanced playstyle; a long-range playstyle; a short-range playstyle; a casual playstyle; or the like. Many other examples are possible. A level balance may be included in the target style for the level, e.g., an indication of how much the level should favour one team or the other in a multi-team/multiplayer game, such as a win rate. The target style for the level may alternatively or additionally comprise a target hit distance, e.g., an average distance over which a player or players can hit a target (where the target is a static target, a non-player character, another player, and/or the like).

The one or more target level features may comprise one or more in-game features. For example, the target features may comprise one or more of: a number of obstacles (or other in-game items) that should be included in the level; a number of hills in the level; and/or one or more target goal positions in the level (e.g., objective locations or the like).

The initialisation data 104 is sampled from a predefined distribution 106. The initialisation data 104 is, in some examples, an m-dimensional vector, where m>1. The predefined distribution 106 is, in some examples, a normal distribution or a uniform distribution, though it will be appreciated that other distributions may alternatively be used.

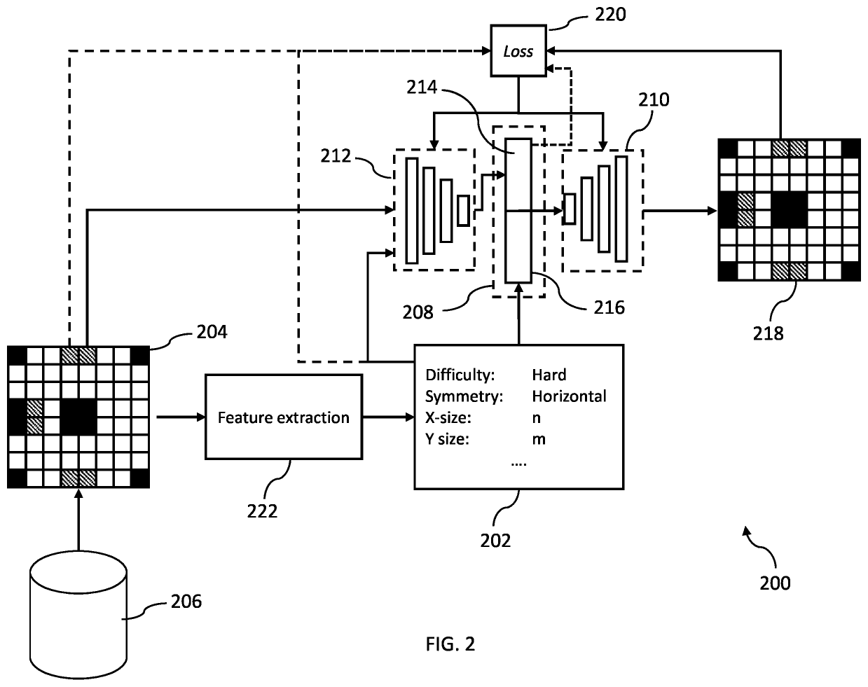

The decoder neural network 110 receives as input the input data 108, for example in the form of an N-dimensional vector, where N=m+k. The decoder network 110 processes the input data 108 through a plurality of layers based on a set of learned parameters to generate the computer game level data 112. The parameters of the decoder neural network 110 were, for example, learned using the method 200 described in relation to FIG. 2.

The plurality of layers of the decoder neural network 110 may comprise one or more (e.g., a plurality) of convolutional layers. Each convolutional layer is configured to apply one or more (e.g., a plurality) convolutional filters to the input to its respective layer. A convolutional layer (e.g., each convolutional layer) is, in some implementations, followed by an activation function. For example, a ReLU activation function can be applied to the output of each convolutional layer.

The plurality of layers of the decoder neural network 110 may further comprise one or more fully connected layers. For example, the initial layer of the decoder neural network 110 is, in some implementations, a fully connected layer that acts to upsample the input data 108.

The output of the decoder neural network 110 comprises data representing a level layout for a computer game. The data representing the level layout may be represented in any suitable way.

For example, the data representing the level layout 112 may be a matrix of categorical values for tiles that are arranged on a 2D grid to make a two-dimensional level, i.e., each component of the matrix is a value indicating a tile type at a corresponding location in the level. As a further example, the data representing the level layout 112 may be a tensor of categorical values for blocks that are arranged on a 3D grid to make a three-dimensional level, i.e., each component of the tensor is a value indicating a block type at a corresponding location in the level. In some examples, the data representing the level layout 112 may comprise one or more image maps representing a three-dimensional level, e.g., height maps, object location maps, etc.

In examples where the target features include a level symmetry, the data representing the level layout 112 may only relate to a part of the level, with the rest of the level being reconstructed during post-processing based on the target symmetry, duplicating the relevant part of the level if necessary. Alternatively, a full level layout may be output by the decoder model 110. If a symmetry is indicated in the target features, parts of such a level may be discarded and replaced by duplicates of a part of the level. This ensures that the symmetry requirements for the level are met.

In some examples, the decoder 110 produces a fixed-size output, i.e., the data representing the level layout 112 is always in the same format/size. A level mask based on a target level size may be used to convert such a fixed-size output into data representing a level layout with the target size. The size masking may, in some examples, be applied before any symmetry masking.

A computer game level may be generated/constructed based on the data representing the level layout 112. A level creator/rendering program (e.g., Blender, World Builder, Unreal, Gaea, or the like) may take the data representing the level layout 112 and convert it into a computer game level ready for use/rendering in gameplay of a computer game.

As an example, the method 100 may be used to generate levels for a “match-3” game. Match-3 games are common in casual mobile gaming environments. Such environments are favourable for level generation due to the demand for continued content creation as a live service and the opportunity to offer personalized content to maintain player engagement. In matching games, coloured tiles can be swapped horizontally or vertically to make them disappear when matched with adjacent tiles of the same colour. In match-3 games, the matching criteria is to align three or more of such tiles. New tiles are randomly added to the board as others disappear until the player achieves a goal or runs out of moves. In a typical match-3 game, the number of levels can reach over ten thousand, and hundreds must be added weekly to keep the players engaged. This leads to a high output, which can lead to repetitive and predictable levels.

In such examples, a target number of moves to complete a level is used as a measure of the target difficulty. A target level size is defined in terms of a number of tiles (also referred to as “cells”) in each of two dimensions, i.e., a width, W, and height. H. The types of symmetry considered are vertical, horizontal, quadrant (vertical and horizontal), and unknown.

The levels are defined in terms of an arrangement of tile-types on a W-by-H grid. For example, a level may be defined in terms of three types of cells: PLAYFIELD cells define locations in the grid where tiles can be placed, and the game can be played; BLOCK cells define the size and shape of the level to which tiles are constrained; and GAP cells resemble BLOCK cells visually, but allow tiles to fall through. The game level data 112 for such a level may, for example, be represented as a matrix of categorical values representing these types of cells. Tile spawning spots may be created as a post processing step, and/or included as another cell type.

In some implementations, the decoder neural network 110 for a match-3 game receives a N-dimensional vector (e.g., 20-dimensional vector) of input data 108, which is the concatenation of the initialisation data (e.g. a latent vector) 104, z, (e.g., 5 dimensions) with the condition information, e.g., a size conditioner and a difficulty conditioner. The size conditioner is in the form of two one-hot vectors, one for the width and one for the height, e.g., 6 dimensions of the width for a width in the range 4 to 9 tiles, 8 dimensions for the height in the range 4 to 11 tiles. One dimension may be used for the difficulty.

The decoder neural network 110 is composed of an FC layer that upsamples this input to 64 dimensions, followed by three layers of transposed convolutions of 32, 16 and 3 filters (i.e., the last layer has the same number as the number of categorical values) and 3×3 kernels. Each layer is followed by a ReLU activation, except for the last one.

As a further example, the method 100 may be used to generate 3D levels for a 3D game environment, such as a first-person action game or third-person action game. In such examples, the computer game level data 112 indicative of a layout of a computer game level may comprise one or more two-dimensional maps of level features, e.g., a height map, an object placement map, a texture map, or the like. The one or more two-dimensional maps may be converted to a three-dimensional game environment. For example, a height map can be converted to a three-dimensional mesh of the game environment, an object placement map can be used to place three-dimensional objects in the environment, etc.

In some examples of 3D level generation, the one or more 2D maps be image of dimensions [30, 30, 3], i.e., 30-by-30 pixels with three colour channels. The decoder neural network 110 comprises a plurality of convolutional layers, having a convolution output sizes of [16,8,8], e.g., conv_out_size=[16, 8, 8]. The kernels may have a size of 3, e.g., kernels=[3, 3, 3, 3]. A padding of 1 may be applied at each layer, e.g., padding=[1, 1, 1, 1]. The convolutions may have strides of 2 and/or 1, e.g., stride=[2, 2, 2, 1]. The hidden layer (i.e., fully connected layer) may have 512 nodes.

Alternatively, the decoder neural network may be based on a ResNet architecture, e.g., a resnet_18 decoder. In such examples, an initial convolutional layer of the ResNet and/or maxpooling may be omitted.

FIG. 2 shows a schematic overview of an example system/method for training a machine learning model to generate a computer game level layout. A set of level features 202 is extracted from a known computer game level 204, Lₙ, taken from a training dataset 206 of known computer game levels. An embedding 214 of the known computer game level 204 is generated from the known computer game level 204 and a set of encoder conditioning information using an encoder model 212. The set of encoder conditioning information is derived from the set of level features 202. The embedding 214 of the known computer game level 204 is combined with a set of decoder conditioning information 216 derived from the level features 202 to generate an encoded representation 208 of the known computer game level 204. The encoded representation 208 is input into a decoder model 210, which processes the encoded representation 208 to generate data representing a candidate computer game level 218, Xₙ. Based on the data representing a candidate computer game level 212, an objective function 220 (also referred to herein as a “loss function”), £, is evaluated. The objective function 220 may comprise a reconstruction loss and a Kullback-Leibler divergence. Parameters of the decoder model 210 and/or encoder model 212 are updated based on values of the objection function 220.

In some implementations, an automated feature extraction process 222 is applied to the known level 204 to generate at least a part of the set of level features 202. The automated feature extraction process 222 comprises, in some examples, playing the known computer game level 204 with one or more reinforcement learning (RL) agents and/or scripted bots in order to extract one or more level features. One or more level features may be based on statistics gathered from one or more (e.g., a plurality) of “playthroughs” of the known level 204 by the one or more RL agents and/or scripted bots. In some examples, such as in levels for multiplayer games, a plurality of reinforcement learning (RL) agents and/or scripted bots may compete to generate the level features. In some of such examples, the plurality of reinforcement learning (RL) agents and/or scripted bots may be divided into subgroups that each represent a different type of player, e.g., different in-game player classes, different playstyles, or the like. This can assist the method 200 in training a generator that will generate levels that are balanced across multiple playstyles and/or player classes. In some implementations, the one or more level features may comprise one or more of: an indication of a level difficulty (e.g., an average number of moves and/or a time taken to complete the known level 204, an average survival time in the known level 204, or the like); an average fraction of the game area explored by the one or more RL agents and/or scripted bots; an indication of a win-to-loss ratio for each type of RL agent/scripted bot; a level size; a level symmetry; and/or the like. One or more (e.g., a plurality) of the level features may be extracted directly from the data representing the known level 204. For example, a level size and/or a level symmetry may be extracted directly from the known level 204 without the need for an RL agent and/or scripted bot.

Alternatively or additionally, one or more (e.g., a plurality) of level features may be extracted based on human testing. One or more (e.g., a plurality) of human testers may play a level, and one or more level features generated based on statistics of the human playthroughs. The one or more level features may, for example, be any of the level features described in relation to the automated feature extraction 222.

In some implementations, the level features may be extracted in advance of the training method 200, and stored in the training dataset 206 alongside the known level data 204. For example, the level features may be generated when the training dataset 206 is created.

The level features 202 are, in some examples, utilised differently by the encoder model 212 and the decoder model 210. For example, were the level features 202 include a symmetry constraint, the symmetry constraint may be applied to the layout of the known computer game level 204, L, by using a mask, M^{sym}, e.g., by performing the element-wise multiplication L. M^{sym}, as described below. A size mask, M^{size}, for the known level may also be generated. A difficult conditioner, d∈[0,1], may be repeated in a 2D map, D, of the same size as the size mask, e.g., D∈ [symbol] ^{W×H}. In such examples, the input to the encoder, Ŷ, will then be Ý=[L∘M^{sym}, M^{size}, D]. Since the input data is pre-processed and symmetry is enforced as a postprocessing step, using symmetry as part of the conditioning information is unnecessary in these examples. For the decoder, the size conditioner may be in the form of two one-hot vectors, h_{W} for the width and h_{H} for the height. These conditioners are concatenated to the sampled latent vector 214, z, to create the input 208 to the decoder, z=[z, h_{W}, h_{H}, d], with d being the difficulty conditioner.

To adapt the cVAE framework to partial generation, in some examples, the input data to the encoder model are pre-processed based on the type of symmetry present in the known level 204. The types of symmetry may, for example, include: a vertical mirror symmetry; a horizontal mirror symmetry; a quadrant mirror symmetry (i.e., both horizontal and vertical mirror symmetry); and/or a rotational symmetry (e.g., two-fold or four-fold rotational symmetry). For example, only the left or right part of the level is of interest in a vertically symmetric level.

The pre-processing may, for example, comprise applying a mask to the data representing the known level 204. The mask acts to mask the redundant parts of the known game level 204. For example, for a two-dimensional game level, for each type of symmetry, a two-dimensional mask Mₙ∈{0, 1}^{W×H} is used to block the redundant part of the level, where W and H correspond to the width and height of the nth dataset sample. This mask is applied to the input known level 204, Lₙ, before encoding so there is consistency over levels with the same symmetry in the latent space. The mask may be applied using Lₙ∘Mₙ, where A∘B is the element-wise product between two matrices A and B. As an example, for horizontal and vertical symmetries on a two-dimensional grid, the non-zero elements of the mask Mn are defined by is [H/2] and j≤[W/2] respectively, where i and j index the height and width of the grid respectively. For quadrant symmetry, both of these constraints apply.

In some implementations, during the creation of the training dataset 206, a respective mask, Mn, coupled with each level sample 204, Lₙ, is created according to the type of symmetry observed in the level, and stored in the training dataset 206.

Ultimately, a symmetry mask specifies parts of the level that should be used for training for a given level, represented with 1, and parts that should be ignored, represented with 0. When computing the reconstruction loss for a candidate level 218, a mask is used to ignore the redundant part of the level.

In some implementations, other than the modifications needed for the partial generation approach, if present, the network follows the VAE objective function/loss in Equation 3. The negative log-likelihood of the output distribution may be used as a reconstruction loss. In some examples, the level data may be represented as a categorical distribution, thus a cross-entropy loss (Equation 1) can be used as the reconstruction loss.

$${ℒ}_{CE} ( \hat{X} , z ) = {𝔼}_{{q}_{ϕ} ( z \vert \hat{X} )} [ log {p}_{θ} ( \hat{X} \vert \hat{z} ) ] \qquad ( 1 )$$

where \hat{X} is the output logits of the decoder masked with the symmetry mask, e.g., \hat{X}=X∘M^{sym} and \hat{Z} is the decoder input. The ground truth level may be represented as L∈{0, . . . ,K}^{W×H} where K corresponds to the number of categorical classes, e.g., tile classes. q_{ϕ} represents the encoder model 212 parametrised by the parameters ϕ. p_{θ} represents the decoder model 210 parametrised by the parameters θ

In other examples, a reconstruction loss may be based on a difference between the known level 204 and the candidate level 218. For example, an L2 loss or an L1 loss may be used as the reconstruction loss. For example, where the known level 204 and candidate level 218 are represented as maps (e.g., in a 3D level example), an L2 loss or an L1 loss may be an appropriate objective function.

In some examples, the objective function further comprises a Kullback-Leibler (KL) divergence, L_{KL}, e.g.:

$${ℒ}_{KL} ( z , \hat{Y} ) = - {D}_{KL} ( {q}_{θ} ( z \vert \hat{Y} ) ‖ 𝒩 ( 0 , I ) ) \qquad ( 2 )$$

where Ŷ is the input to the encoder model and z is a latent vector sampled from the encoded distribution, e.g., a 5-dimensional latent vector for the match-3 examples described herein. [symbol] is a normal distribution.

The objective function may then be a combination of the reconstruction loss and the KL divergence, e.g.:

$$ℒ = {ℒ}_{LL} + {ℒ}_{KL} \qquad ( 3 )$$

An optimisation routine is applied to the objective function 220 to determine updates to the parameters of the encoder model 212 and decoder model 210. In some examples, the updates are determined based on a batch of training data, i.e., a combination of individual objective function values, each from a respective known level 204. For example, an average value of the objective functions for the batch may be used to determine the parameter updates. The size of each batch may, for example, be between 50 and 200, e.g., 100.

As an example of an optimisation routine, stochastic gradient descent may be applied to the objective function to determine the parameter updates. In some examples, the Adam optimiser is used as the optimisation routine. The learning rate of the Adam optimiser in such examples may be between 10⁻⁶ and 10⁻⁴, e.g., 10⁻⁵ or 5×10⁻⁶.

The method may be iterated until one or more threshold conditions are satisfied. The one or more threshold conditions may, for example, comprise a threshold number of training epochs. The threshold number of training epochs may, for example, be between 10000 and 30000 epochs, e.g., 24000 epochs. Checkpoints may be taken after a predetermined number of epochs, e.g., every 500 epochs. Alternatively or additionally, the threshold condition may comprise reaching a respective threshold value on one or more evaluation metrics.

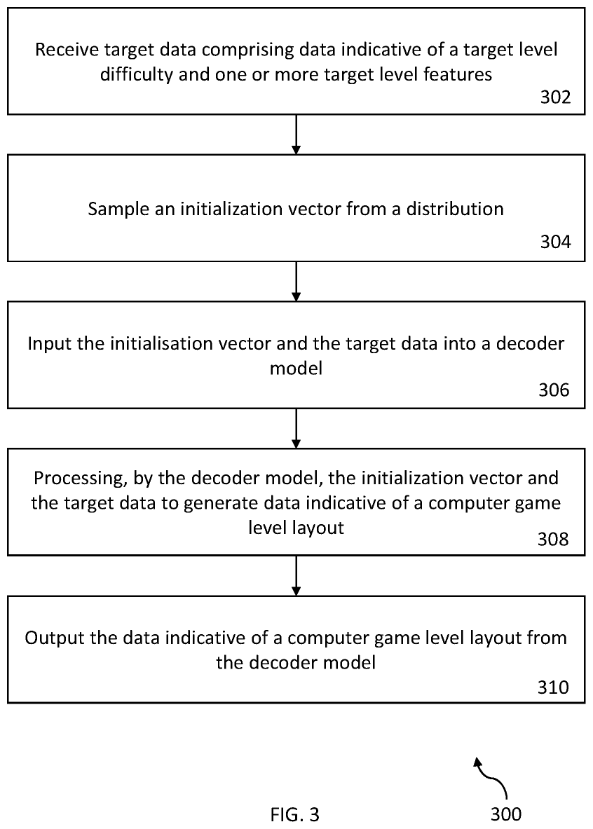

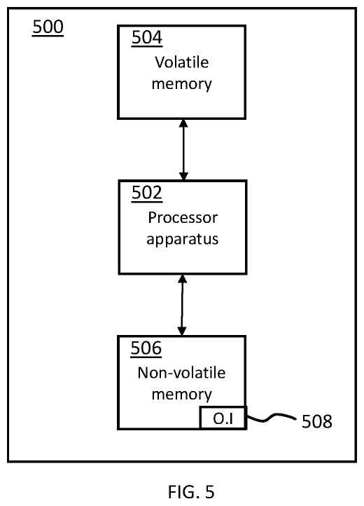

FIG. 3 shows a flow diagram of an example method 300 for generating a computer game level. The method 300 corresponds to the method 100 described in relation to FIG. 1. For convenience, the operations of the method 300 are described with reference to a system that performs the operations, e.g., a computer system comprising one or more processors and a memory. An example of such a system is described in relation to FIG. 5. The computer game level may be a game level for a two-dimensional game environment. Alternatively, the computer game level may be a game level for a three-dimensional game environment.

At operation 302, the system receives target data comprising data indicative of a target level difficulty and one or more target level features. The target level features and target difficulty may be provided/selected by a user.

The target difficulty may be represented numerically. For example, the target difficultly may correspond to a target number of moves and/or a target time to complete the level. Alternatively or additionally, the target difficulty may be represented categorically, e.g., as “easy”, “normal”, “hard”, or the like.

In some implementations, the one or more target level features comprises one or more level dimensions, e.g., a height, width and/or depth of the level. The one or more target features may alternatively or additionally comprise an indication of a level symmetry, e.g., axes of a mirror symmetry, a rotational symmetry, a group, etc. The one or more target features may alternatively or additionally comprise a target style for the level. The target style defines one or more style features of the level being generated.

At operation 304, the system samples an initialization vector from a distribution. The distribution may be a normal distribution or a uniform distribution. The initialization vector may be an n-component vector, where n>1, e.g., 5.

At operation 306, the system inputs the initialisation vector and the target data into a decoder model. The initialisation vector and the target data may be concatenated to form a set of input data for the decoder model.

At operation 308, the system processes, using the decoder model, the initialization vector and the target data to generate data indicative of a computer game level layout.

The decoder neural network model may comprise one or more fully connected layers configured to up-sample the input data to the decoder model. The decoder model may further comprise one or more convolutional layers subsequent to the one or more fully connected layers. One or more of the convolutional layers (e.g., each layer save for the final convolutional layer) may be followed by a non-linear activation function, such as a ReLU, sigmoid, or tanh function.

At operation 310, the system outputs the data indicative of a computer game level layout from the decoder model. The data indicative of a candidate computer game level may comprise: a matrix of tile values/identities for a two-dimensional game; a tensor of tile/block values/identities for a three-dimensional game; one or more image maps derived from the game level (e.g., a height map, an object placement map, and/or a texture map), or the like.

In examples where a symmetry is specified in the target level features, a full level layout may be reconstructed from the data indicative of a computer game level layout, for example by copying the generated game level layout at locations and/or in orientations specified by the symmetry.

The method 300 may further cause a computer game level to be generated based on the data indicative of a computer game level layout. For example, the data indicative of a computer game level layout may be converted to a full representation of the computer game level (e.g., textured, converted to a mesh, converted to a computer game environment, etc). The computer game level may at least in part be rendered on a computing device during gameplay.

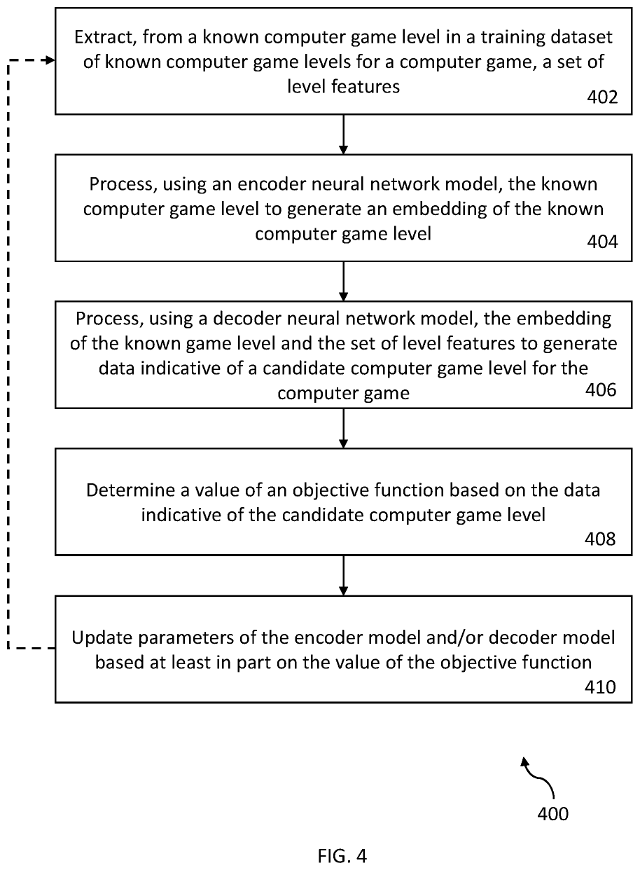

FIG. 4 shows a flow diagram of an example of a method for training a model to generate a computer game level. The method 400 corresponds to the method 200 described in relation to FIG. 2. For convenience, the operations of the method 300 are described with reference to a system that performs the operations, e.g., a computer system comprising one or more processors and a memory. An example of such a system is described in relation to FIG. 5.

At operation 402 the system extracts, from a known computer game level in a training dataset of known computer game levels for a computer game, a set of level features. The set of level features may be extracted from the known computer game level using a reinforcement learning algorithm, one or more scripted bots and/or one or more human testers. The set of level features may comprise one or more of: a difficulty measure for the level (e.g., an average number of moves, an average time taken to complete the level, and/or a categorical difficulty); a dominant playstyle for the level; a level style; a level size; an indication of a level symmetry (e.g., rotational and/or mirror symmetries); and/or the like. The set of level features may be represented by a k-dimensional vector, with k>1.

At operation 404, the system processes, using an encoder neural network model, data representing the known computer game level to generate an embedding of the known computer game level. Encoder conditional information based on extracted level features can be used to modify the level before the encoder and/or be concatenated to the level before the encoder, i.e., encoder input data may be generated from the known computer game level and the extracted level features.

The embedding may be in the form of an m-dimensional vector, where m>1, e.g., 5. The encoder network may process data representing a layout of the known level, e.g., a matrix of tile values/identities for a two-dimensional game, a tensor of tile/block values/identities for a three-dimensional game, one or more image maps derived from the game level (e.g., a height map, an object placement map, and/or a texture map), or the like.

The encoder neural network may comprise one or more (e.g., a plurality) of convolutional layers. One or more (e.g., each) of the convolutional layers may be followed by a non-linear activation function, such as a ReLU function, a sigmoid function, or the like. The encoder neural network may further comprise one or more fully connected layers configured to down-sample the output of the one or more convolutional layers to generate the embedding of the known computer game level.

In some examples where the set of level features comprises a level symmetry of the known computer game level, processing, using the encoder neural network model, the known computer game level to generate the embedding of the known computer game level may comprise generating a mask based on the level symmetry of the known computer game level. The mask may be a matrix/tensor of zeros or ones. The mask is applied to the known computer game level to generate a masked known computer game level. The encoder neural network model processes the masked known computer game level to generate the embedding of the known computer game level.

At operation 406, the system processes, using a decoder neural network model, the embedding of the known game level and the set of level features to generate data indicative of a candidate computer game level for the computer game. The embedding of the known game level and the set of level features may be concatenated to form an N-dimensional vector of input data, where N=m+k.

The decoder neural network may comprise one or more fully connected layers configured to up-sample the input data comprising the embedding of the known game level and the set of level features. The fully connected layer may be followed by one or more (e.g., a plurality) of convolutional layers. One or more (e.g., each) of the convolutional layers may be followed by a non-linear activation function, such as a ReLU function, a sigmoid function, or the like. In some examples, the final convolutional layer is not followed by an activation function.

The data indicative of a candidate computer game level for the computer game may be in the same format/form as the input to the encoder neural network. For example, the data indicative of a candidate computer game level may comprise: a matrix of tile values/identities for a two-dimensional game; a tensor of tile/block values/identities for a three-dimensional game; one or more image maps derived from the game level (e.g., a height map, an object placement map, and/or a texture map), or the like.

At operation 408, the system determines a value of an objective function based on the data indicative of the candidate computer game level. The objective function may compare the data indicative of the candidate computer game level to the data indicative of the known computer game level that was input into the encoder.

In some examples, the objective function comprises a reconstruction loss, such as a cross entropy loss, and/or a Kullback-Leibler divergence.

In examples where the input to the encoder is data representing a masked known computer game level, determining the value of the objective function comprises applying the mask to the data indicative of the candidate computer game level to generate masked candidate level data. The value of the objective function is determined based at least in part on the masked candidate level data, i.e., the parts covered by the mask are ignored when determining the objective function value.

At operation 410, the system update parameters of the encoder model and/or decoder model based at least in part on the value of the objective function. An optimization function, such as stochastic gradient descent, may be applied to the objective function to determine the parameter updates.

In some examples, operation 410 is performed based on applying operations 402 to 408 to a batch/mini-batch of training examples, e.g., to a plurality of known game levels from the training dataset. The objective function in such examples may be an average (e.g., a mean) of individual objective function values from respective known game levels from the training dataset.

Operations 402 to 410 may be iterated over the training dataset until one or more threshold conditions are satisfied. The one or more threshold conditions may comprise one or more of: a threshold number of training epochs; and/or a threshold performance on a test dataset and/or on inferred levels following their own conditions.

FIG. 5 shows a schematic example of a system/apparatus 500 for performing any of the methods described herein. The system/apparatus shown is an example of a computing device. It will be appreciated by the skilled person that other types of computing devices/systems may alternatively be used to implement the methods described herein, such as a distributed computing system.

The apparatus (or system) 500 comprises one or more processors 502. The one or more processors control operation of other components of the system/apparatus 500. The one or more processors 502 may, for example, comprise a general-purpose processor. The one or more processors 502 may be a single core device or a multiple core device. The one or more processors 502 may comprise a Central Processing Unit (CPU) or a graphical processing unit (GPU). Alternatively, the one or more processors 502 may comprise specialized processing hardware, for instance a RISC processor or programmable hardware with embedded firmware. Multiple processors may be included.

The system/apparatus comprises a working or volatile memory 504. The one or more processors may access the volatile memory 504 in order to process data and may control the storage of data in memory. The volatile memory 504 may comprise RAM of any type, for example Static RAM (SRAM), Dynamic RAM (DRAM), or it may comprise Flash memory, such as an SD-Card.

The system/apparatus comprises a non-volatile memory 506. The non-volatile memory 506 stores a set of operation instructions 508 for controlling the operation of the processors 502 in the form of computer readable instructions. The non-volatile memory 506 may be a memory of any kind such as a Read Only Memory (ROM), a Flash memory or a magnetic drive memory.

The one or more processors 502 are configured to execute operating instructions 608 to cause the system/apparatus to perform any of the methods described herein. The operating instructions 508 may comprise code (i.e. drivers) relating to the hardware components of the system/apparatus 500, as well as code relating to the basic operation of the system/apparatus 500. Generally speaking, the one or more processors 502 execute one or more instructions of the operating instructions 508, which are stored permanently or semi-permanently in the non-volatile memory 506, using the volatile memory 504 to store temporarily data generated during execution of said operating instructions 508.

Implementations of the methods described herein may be realized as in digital electronic circuitry, integrated circuitry, specially designed ASICs (application specific integrated circuits), computer hardware, firmware, software, and/or combinations thereof. These may include computer program products/non-transitory computer readable media (such as software stored on e.g. magnetic discs, optical disks, memory, Programmable Logic Devices) comprising computer readable instructions that, when executed by data processing apparatus, such as that described in relation to FIG. 5, cause the data processing apparatus to perform one or more of the methods described herein.

Any system feature as described herein may also be provided as a method feature, and vice versa. As used herein, means plus function features may be expressed alternatively in terms of their corresponding structure. In particular, method aspects may be applied to system aspects, and vice versa.

Furthermore, any, some and/or all features in one aspect can be applied to any, some and/or all features in any other aspect, in any appropriate combination. It should also be appreciated that particular combinations of the various features described and defined in any aspects of the invention can be implemented and/or supplied and/or used independently.

Although several embodiments have been shown and described, it would be appreciated by those skilled in the art that changes may be made in these embodiments without departing from the principles of this disclosure, the scope of which is defined in the claims.

It should be understood that the original applicant herein determines which technologies to use and/or productize based on their usefulness and relevance in a constantly evolving field, and what is best for it and its players and users. Accordingly, it may be the case that the systems and methods described herein have not yet been and/or will not later be used and/or productized by the original applicant. It should also be understood that implementation and use, if any, by the original applicant, of the systems and methods described herein are performed in accordance with its privacy policies. These policies are intended to respect and prioritize player privacy and are believed to meet or exceed government and legal requirements of respective jurisdictions. To the extent that such an implementation or use of these systems and methods enables or requires processing of user personal information, such processing is performed (i) as outlined in the privacy policies; (ii) pursuant to a valid legal mechanism, including but not limited to providing adequate notice or where required, obtaining the consent of the respective user; and (iii) in accordance with the player or user's privacy settings or preferences. It should also be understood that the original applicant intends that the systems and methods described herein, if implemented or used by other entities, be in compliance with privacy policies and practices that are consistent with its objective to respect players and user privacy.

What is claimed is:

1. A computer implemented method comprising:
extracting, from a known computer game level in a training dataset of known computer game levels for a computer game, a set of level features;
processing, using an encoder neural network model, the known computer game level to generate an embedding of the known computer game level;
processing, using a decoder neural network model, the embedding of the known game level and the set of level features to generate data indicative of a candidate computer game level for the computer game;
determining a value of an objective function based on the data indicative of the candidate computer game level; and
updating parameters of the encoder model and/or decoder model based at least in part on the value of the objective function.

2. The computer implemented method of claim 1, wherein extracting, from the known computer game level in the training dataset of known computer game levels for the computer game, the set of level features comprises:
extracting the set of level features from the known computer game level using a reinforcement learning algorithm or a scripted bot.

3. The computer implemented method of claim 1, wherein the set of level features comprises one or more of: data indicative of a level difficulty of the known computer game level; a level symmetry of the known computer game level; a level size of the known computer game level; and/or a level style of the known computer game level.

4. The computer implemented method of claim 1:
wherein the set of level features comprises a level symmetry of the known computer game level; and
wherein processing, using the encoder neural network model, the known computer game level to generate the embedding of the known computer game level comprises:
generating a mask based on the level symmetry of the known computer game level;
applying the mask to the known computer game level to generate a masked known computer game level; and
processing, by the encoder neural network model, the masked known computer game level to generate the embedding of the known computer game level.

5. The computer implemented method of claim 4, wherein determining the value of an objective function based on the data indicative of the candidate computer game level comprises:
applying the mask to the data indicative of the candidate computer game level to generate masked candidate level data; and
determining the value of an objective function based on the masked candidate level data.

6. The method of claim 1, wherein the encoder neural network model comprises:
one or more convolutional layers; and
one or more fully connected layers configured to down-sample the output of the one or more convolutional layers to generate the embedding of the known computer game level.

7. The method of claim 6, wherein the decoder neural network model comprises:
one or more fully connected layers configured to up-sample decoder input data comprising the embedding of the known game level and the set of level features; and
one or more convolutional layers subsequent to the one or more fully connected layers.

8. The method of claim 1 wherein the objective function comprises a cross entropy loss and/or a Kullback-Leibler divergence.

9. The method of claim 1 wherein the known computer game level and candidate computer game level are game levels for a two-dimensional game environment or a three-dimensional game environment.

10. The method of claim 1, wherein processing, using the encoder neural network model, the known computer game level to generate an embedding of the known computer game level comprises:
determining a set of encoder conditioning data from features extracted from the known computer game level;
generating encoder input data from the known computer game level based on the set of encoder conditioning data; and
processing, by the encoder neural network model, the encoder input data to generate the embedding of the known computer game level,
wherein the level features comprise one or more of: a level difficulty; a level size; and/or a level symmetry.

11. A computer implemented method comprising:
receiving target data comprising data indicative of a target level difficulty and one or more target level features;
sampling an initialisation vector from a distribution;
inputting the initialisation vector and the target data into a decoder model;
processing, by the decoder model, the initialisation vector and the target data to generate data indicative of a computer game level layout; and
outputting the data indicative of a computer game level layout from the decoder model.

12. The method of claim 11, wherein the decoder neural network model comprises:
one or more fully connected layers configured to up-sample decoder input data comprising the embedding of the known game level and the set of level features; and
one or more convolutional layers subsequent to the one or more fully connected layers.

13. The method of claim 11, further comprising causing a computer game level to be generated based on the data indicative of a computer game level layout.

14. The method of claim 11, wherein the computer game level is a game level for a two-dimensional game environment.

15. The method of claim 11, wherein the computer game level is a game level for a three-dimensional game environment.

16. The method of claim 15, wherein the data indicative of a computer game level layout comprises one or more image maps corresponding to one or more of: a height map; an object placement map; and/or a texture map.

17. A system comprising:
one or more processors; and
a non-volatile computer readable storage medium comprising computer readable instructions that, when executed by the one or more processors, cause the system to perform a method comprising:
receiving target data comprising data indicative of a target level difficulty and one or more target level features;
sampling an initialisation vector from a distribution;
inputting the initialisation vector and the target data into a decoder model;
processing, by the decoder model, the initialisation vector and the target data to generate data indicative of a computer game level layout; and
outputting the data indicative of a computer game level layout from the decoder model.

18. The system of claim 17, wherein the decoder neural network model comprises:
one or more fully connected layers configured to up-sample decoder input data comprising the embedding of the known game level and the set of level features; and
one or more convolutional layers subsequent to the one or more fully connected layers.

19. The system of claim 17, wherein the computer readable instructions further cause the system to generate a computer game level based on the data indicative of a computer game level layout.

20. The system of claim 17, wherein the computer game level is a game level for a two-dimensional game environment or a three-dimensional game environment.
